(19) United States
(12) Patent Application Publication
(10) Pub. No.: US 2008/0006801 A1
(43) Pub. Date: Jan. 10, 2008

(54) Pantagraph-type jack

(75) Inventor: Noriyuki Kikuchi, Saitama (JP)

Correspondence Address: CARRIER BLACKMAN AND ASSOCIATES, 24101 NOVI ROAD, SUITE 100, NOVI, MI, 48375, US

(73) Assignee: Rikenkaki Kogyo Kabushiki Kaisha, Sakado-shi (JP)

(21) Appl. No.: 11/824,531

(22) Filed: Jun. 29, 2007

(30) Foreign Application Priority Data
Jul. 10, 2006 (JP) 2006-189419

(51) Int. Cl. B66F 3/00

(52) U.S. Cl. 254/126

(57) ABSTRACT

In a pantagraph-type jack, a lower reinforcement plate is integrally provided at an inner end of a bottom plate portion of each lower arm so as to extend therefrom in parallel with a corresponding lower pivot, and a lower recess is formed in an upper surface of a flange portion of each lower enforcement plate so that the lower recess receives a part of an outer peripheral surface of a threaded rod when a load bearing platform is lowered to a lowermost position. Also, an upper reinforcement plate having the same structure is integrally provided at an inner end of an upper plate portion of each upper arm. Thus, it is possible to firmly restrict inward falling of side plate portions of the lower arms and upper arms, and to lower the load bearing platform to a lowermost position without interference by the above-described reinforcement structure.

### CROSS-REFERENCE TO RELATED APPLICATIONS

The present invention claims priority under 35 USC 119 based on Japanese patent application No. 2006-189419, filed on Jul. 10, 2006. The entirety of the subject matter of this priority document is incorporated by reference herein.

### BACKGROUND OF THE INVENTION

1. Field of the Invention

The present invention relates to a pantagraph-type jack, particularly to an improvement of a pantagraph-type jack comprising: a base; a load bearing platform; a pair of right and left lower arms arranged into a V-shape, formed into an upwardly-opened angular U-shape in section, and having inner ends swingably connected through a pair of right and left lower pivots to the base; a pair of right and left upper arms arranged into an inverted V-shape, formed into a downwardly-opened angular U-shape in section, and having inner ends swingably connected through a pair of right and left upper pivots to the load bearing platform; outer ends of the right and left lower arms and outer ends of right and left upper arms being connected to each other via first and second connecting shafts, respectively; a threaded rod supported on the first connecting shaft in a rotatable but axially non-movable manner, and screwed into a threaded bore provided in the second connecting shaft, lower sector gears formed at the inner ends of the right and left lower arms so as to be meshed with each other; and upper sector gears formed at the inner ends of the right and left upper arms so as to be meshed with each other.

2. Description of the Prior Art

Such a pantagraph-type jack is already known as disclosed in, for example, Japanese Patent Application Laid-open No. 9-240995.

In lower arms and upper arms of the conventional pantagraph-type jack, when they receive a load, outward falling of their side plate portions in the vicinity of lower pivots and upper pivots is restricted by opposite side plate portions of a base and a load bearing platform. However, much consideration is not given to inward falling thereof.

### SUMMARY OF THE INVENTION

The present invention has been achieved in view of the above-mentioned circumstances, and it is an object of the present invention to provide a pantagraph-type jack in which inward falling of side plate portions of lower arms and upper arms in the vicinity of lower pivots and upper pivots is firmly restricted by a reinforcement structure, and a load bearing platform can be lowered to a lowermost position without interference by the reinforcement structure.

In order to achieve the above-mentioned object, according to a first feature of the present invention, there is provided a pantagraph-type jack comprising: a base; a load bearing platform; a pair of right and left lower arms arranged into a V-shape, formed into an upwardly-opened angular U-shape in section, and having inner ends swingably connected through a pair of right and left lower pivots to the base; a pair of right and left upper arms arranged into an inverted V-shape, formed into a downwardly-opened angular U-shape in section, and having inner ends swingably connected through a pair of right and left upper pivots to the load bearing platform; outer ends of the right and left lower arms and outer ends of right and left upper arms being connected to each other via first and second connecting shafts, respectively; a threaded rod supported on the first connecting shaft in a rotatable but axially non-movable manner, and screwed into a threaded bore provided in the second connecting shaft, lower sector gears formed at the inner ends of the right and left lower arms so as to be meshed with each other; and upper sector gears formed at the inner ends of the right and left upper arms so as to be meshed with each other, wherein the pantagraph-type jack further comprises: a lower reinforcement plate integrally provided at an inner end of a bottom plate portion of each lower arm so as to extend therefrom in parallel with the corresponding lower pivot, and integrally including a flange portion which has tip ends bending in right and left directions so as to abut on opposite side plate portions of each lower arm; a lower recess formed in an upper surface of the flange portion of each lower enforcement plate so that the lower recess receives a part of an outer peripheral surface of the threaded rod when the load bearing platform is lowered to a lowermost position; an upper reinforcement plate integrally provided at an inner end of an upper plate portion of each upper arm so as to extend therefrom in parallel with the corresponding upper pivot, and integrally including a flange portion which has tip ends bending in right and left directions so as to abut on opposite side plate portions of each upper arm; and an upper recess formed in an lower surface of the flange portion of each upper enforcement plate so that the upper recess receives a part of an outer peripheral surface of the threaded rod when the load bearing platform is lowered to a lowermost position.

With the first feature, at the inner end of each side plate portion of the lower arms and the upper arms, the inner side surface abuts on the end surface of the flange portion, having a high buckling strength, of the lower and upper reinforcement plates, whereby the inward falling of the side plate portion is firmly restricted to improve durability of the side plate portion. Further, when the load bearing platform is lowered to the lowermost position, parts of the threaded rod is received in the recesses of the flange portion, and thus the jack can be compactly folded without interference by the lower and upper reinforce plates. Furthermore, even if the outer peripheral surface of the threaded rod abuts on the inner surfaces of the recesses of the flange portions, there is no fear that the abutment damages the threaded portion of the threaded rod, because areas of the inner surfaces of the recesses of the flanges are relatively large.

According to a second feature of the present invention, in addition to the first feature, the pantagraph-type jack further comprises: an inwardly-bending rib formed from an upper edge of the opposite side plate portions to an inner edge of each lower arm, a part of the rib comprising the lower sector gear, the flange portion of the lower enforcement plate abutting on an inner side surface of the lower sector gear; and an inwardly-bending rib formed from a lower edge of the opposite side plate portions to an inner edge of each upper arm, a part of the rib comprising the upper sector gear, the flange portion of the upper enforcement plate abutting on an inner side surface of the upper sector gear.

With the second feature, when the flanges, having a high rigidity, of the upper and lower reinforcement plates abut on the inner side surfaces of the side plate portions of the lower arms and the upper surfaces, they also abut on the inner side surfaces of the lower and upper sector gears having a high rigidity, thereby further firmly restricting the inward falling of the side plate portions of the lower arms.

The above-mentioned objectives, other objectives, characteristics and advantages of the present invention will become apparent from a preferred embodiment, which will be described in detail below by reference to the attached drawings.

### BRIEF DESCRIPTION OF THE DRAWINGS

FIG. 1 is a front view of a pantagraph-type jack according to an embodiment of the present invention.

FIG. 2 is a plan view of the pantagraph-type jack with vertically cutaway portions.

FIG. 3 is a cross-sectional view taken along a line 3-3 in FIG. 1.

FIG. 4 is a cross-sectional view taken along a line 4-4 in FIG. 3.

FIG. 5 is a cross-sectional view taken along a line 5-5 in FIG. 4.

FIG. 6 is a perspective view of an essential portion of a lower arm.

### DESCRIPTION OF THE PREFERRED EMBODIMENT

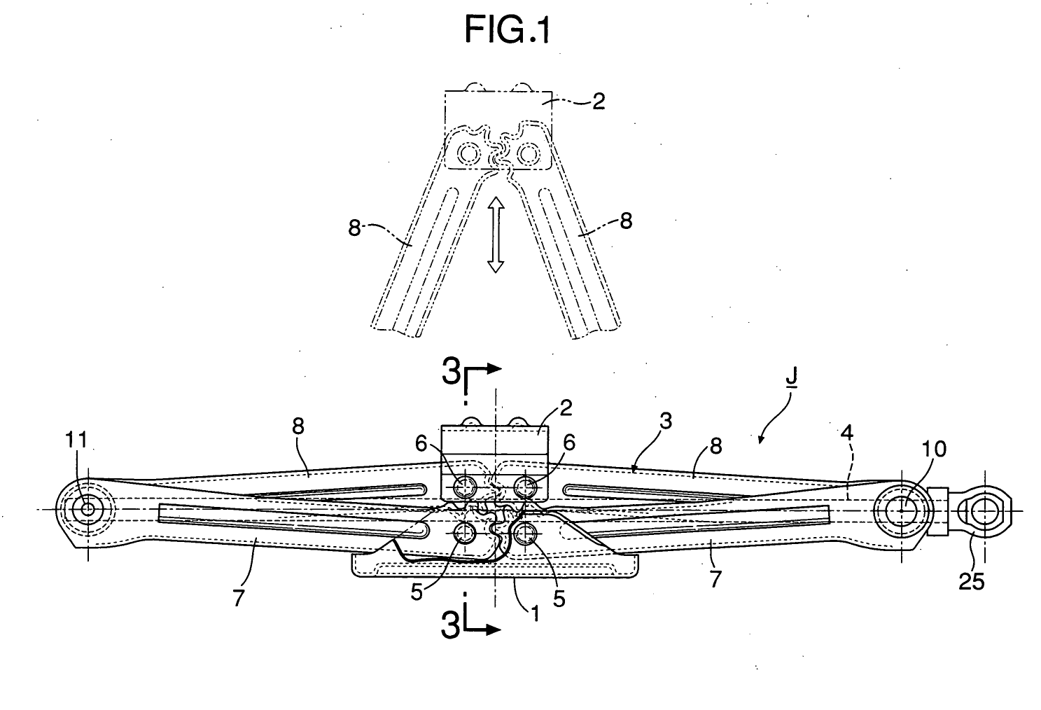

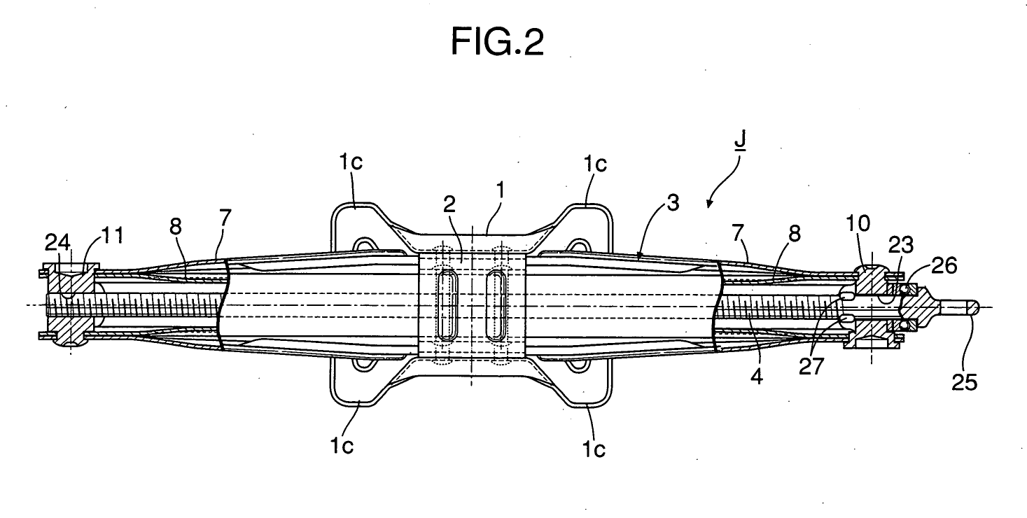

First, in FIGS. 1 and 2, a jack J is a so-called pantagraph-type having four link arms connected in a pantagraphic manner. The jack J includes a base 1, a load bearing platform 2 arranged directly on the base 1, a link mechanism 3 which connects the base 1 and the load bearing platform 2 to each other, and a threaded rod 4 for raising and lowering the load bearing platform 2 by driving the link mechanism 3.

As shown in FIGS. 1 to 3, the base 1 is one steel plate bent into an angular U-shape, and comprises: a pair of side plate portions 1a and 1a opposed to each other in the front-rear direction, that is, in a width direction of the Jack J; and a bottom plate portion 1b integrally connecting the lower ends of the side plate portions 1a and 1a to each other. The bottom plate 1b is integrally formed with ground legs 1c and 1c protruding in the front-rear direction from opposite left and right ends of the bottom plate 1b.

The load bearing platform 2 is one steel plate bent into an angular U-shape, and comprises: a pair of side plate portions 2a and 2a opposed in the front-rear direction at an interval narrower than that between opposite side plate portions 1a and 1a of the base 1; and an upper plate portion 2b integrally connecting the upper ends of the side plate portions 2a and 2a to each other.

The link mechanism 3 comprises: a pair of left and right lower arms 7 and 7 in which inner ends are swingably connected to the base 1 respectively through a pair of left and right lower pivots 5 and 5 so as to be arranged into an inverted V-shape; a pair of left and right upper arms 8 and 8 in which the inner ends are swingably connected to the load bearing platform 2 respectively through a pair of left and right upper pivots 6 and 6 so as to be arranged into a V-shape; a first connecting shaft 10 swingably connecting outer end portions of one lower arm 7 and one upper arm 8 to each other; and a second connecting shaft 11 swingably connecting outer end portions of the other lower arm 7 and the other upper arm 8.

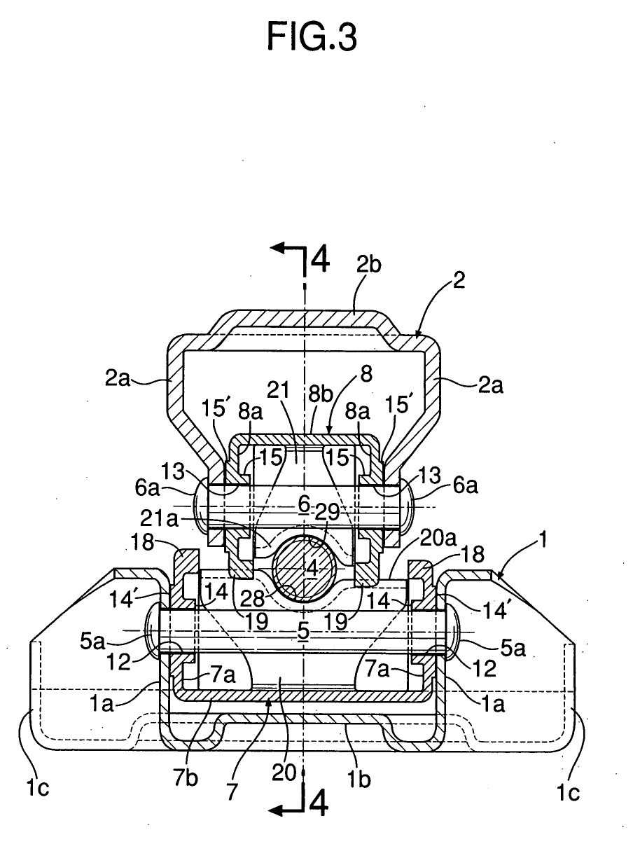

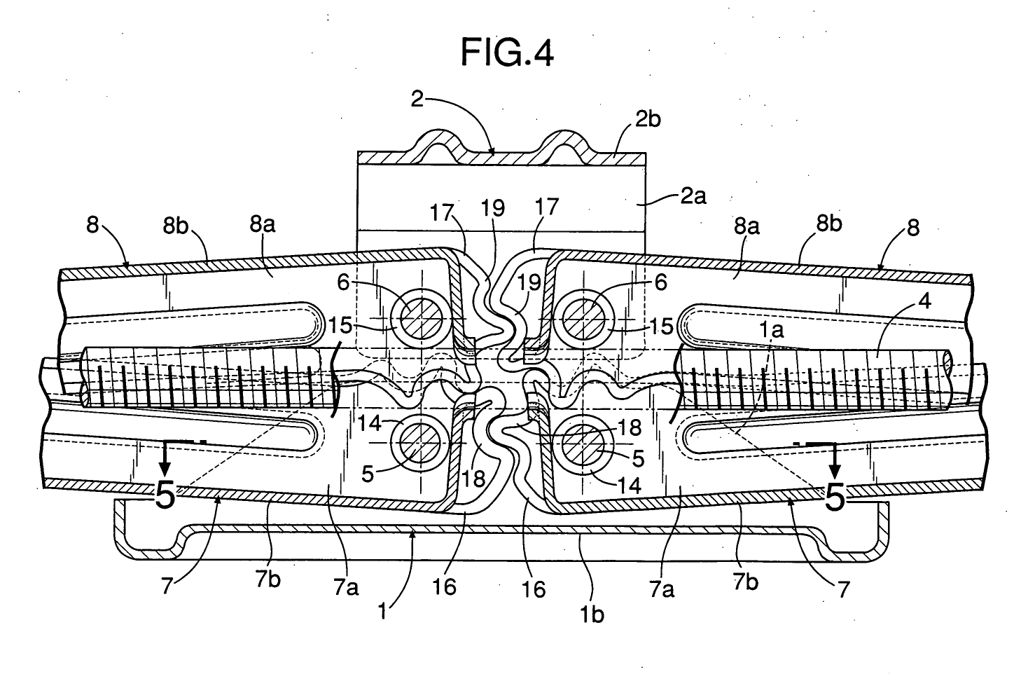

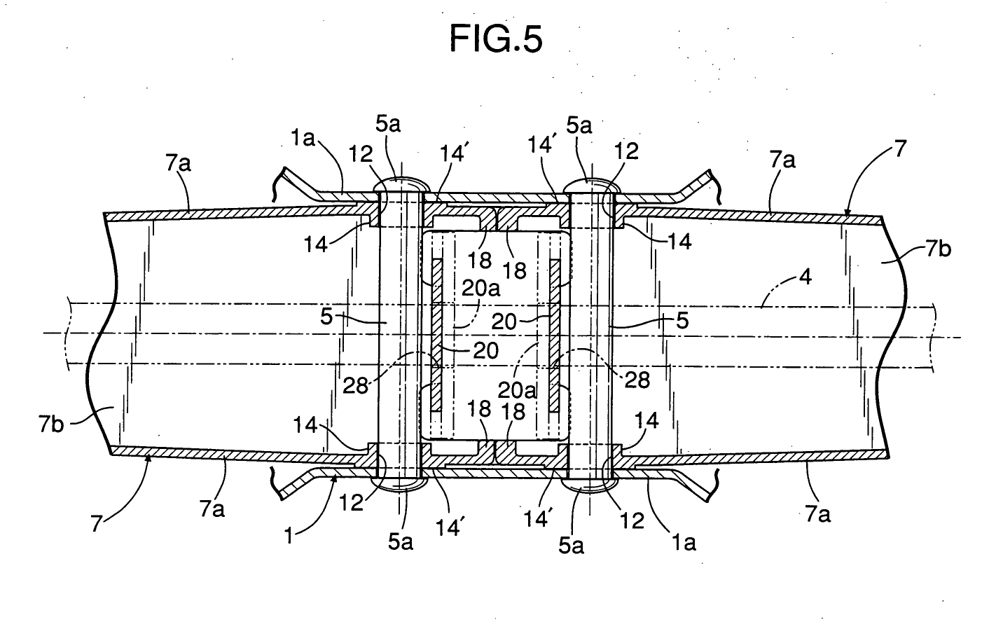

As shown in FIGS. 3 to 6, each lower arm 7 made of one steel plate. The lower arm 7 comprise: a pair of side plate portions 7a and 7a opposed to each other in the front-rear direction; and a bottom plate portion 7b integrally connecting their lower side edges. The inner ends of the side plate portions 7a and 7a are inserted between the side plate portions 1a and 1a of the base 1, and concurrently connected to the side plate portions 1a and 1a of the base 1 through the corresponding lower pivot 5. The opposite ends of the lower pivots 5 and 5 are formed with enlarged portions 5a and 5a abutting on the outer surface of the base 1 in order to prevent the lower pivots 5 and 5 form being pulled out.

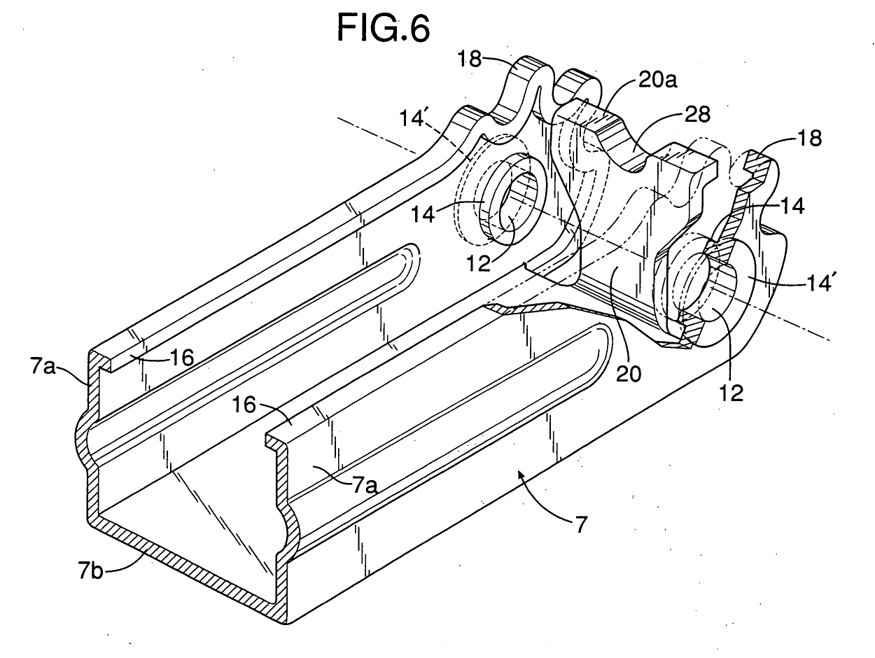

As shown in FIGS. 3 and 6, lower pivot receiving bores 12 and 12 support the lower pivots 5 and 5 of the opposite side plate portions 7a and 7a of each lower arm 7. Each lower pivot receiving bore 12 is extended by a cylindrical inner boss 14 and a disc-shaped outer boss 14′ projectingly provided on inner and outer surfaces, respectively, of each plate portion 7a. The outer boss 14′ and 14′ are formed to have a diameter larger than the inner bosses 14 and 14. The outer end surfaces of the outer bosses 14′ and 14′ rotatably contact the inner surfaces of the corresponding side plate portions 1a and 1a of the base 1.

Likewise, each upper arm 8 is made of one steel plate. The upper arms 8 and 8 comprise: a pair of side plate portions 8a and 8a opposed to each other in the front-rear direction; and an upper plate portion 8b integrally connecting the upper side edges of the side plate portions 8a and 8a to each other. The inner ends of the opposite side plate portions 8a and 8a are inserted between the side plate portions 2a and 2a of the load bearing platform 2, and the side plate portions 8a and 8a concurrently connected to the side plate portions 2a and 2a of the load bearing platform 2 through the corresponding upper pivot 6. The opposite ends of the upper pivots 6 and 6 are formed with enlarged portions 6a and 6a abutting on the outer surface of the load bearing platform 2 in order to prevent the upper pivots 6 and 6 form being pulled out.

Also in this case, upper pivot receiving bores 13 and 13 support the upper pivots 6 and 6 of the opposite side plate portions 8a and 8a of each upper arm 8. Each upper pivot receiving bore 13 is extended by cylindrical an inner boss 15 and a disc-shaped outer boss 15′ projectingly provided on inner and outer surfaces, respectively, of each side plate portions 8a. The outer bosses 15′ and 15′ are formed to have a diameter larger than the inner bosses 15 and 15. The outer end surfaces of the outer bosses 15′ and 15′ rotatably contact the inner surfaces of the corresponding side plate portions 2a and 2a of the load bearing platform 2.

The inner bosses 14 and 14; 15 and 15 are formed by burring. The outer bosses 14′ and 14′; 15′ and 15′ are formed by extruding. With these processes, the inner bosses 14 and 14; 15 and 15 as well as the outer bosses 14′ and 14′; 15′ and 15′ can be formed at a low cost. In this structure, forming the outer bosses 14′ and 14′; 15′ and 15′ into a disc-shape having a larger diameter than the outer bosses 14′ and 14′ and 15′ and 15′ advantageously facilitates the extruding of the outer bosses 14′ and 14′; 15′ and 15′ without interference by the inner bosses 14 and 14; 15 and 15.

As apparent from FIG. 2, the interval between the opposite side plate portions 7a and 7a of each lower arm 7 is larger than the interval between opposite side portions 8a and 8a of each upper arm 8. The outer ends of the opposite side plate portions 8a and 8a of each upper arm 8 are superposed on the inner side portions of the outer ends of opposite side plate portions 7a and 7a of each lower arm 7, and these outer ends are connected to each other by the first and second connecting shafts 10 and 11.

Referring again to FIGS. 3 to 6, the opposite side plate portions 7a and 7a of the left and right lower arms 7 and 7 are provided with a series of inwardly-bent ribs 16 and 16 formed from an upper edge portion to an inner edge portion. At inner ends of the lower arms 7 and 7, the ribs 16 and 16 are formed into a tooth shape to form sector gears 18 and 18 so as to engage with each other. The lower sector gears 18 and 18 have rotation centers at the corresponding lower pivots 5 and 5. The left and right lower arms 7 and 7 can synchronize with each other by engagement between the lower sector gears 18 and 18 when vertically swinging around the lower pivots 5 and 5.

Likewise, the opposite side plate portions 8a and 8a of the left and right upper arms 8 and 8 are provided with a series of inwardly-bent ribs 17 and 17 formed from the lower edge portion to the inner end portion, respectively. At inner ends of the upper arms 8 and 8, the ribs 17 and 17 are formed into a teeth-shaped to form upper sector gears 19 and 19 so to engage with each other. The upper sector gears 19 and 19 have rotation centers at the corresponding upper pivots 6 and 6. The left and right upper arms 8 and 8 can synchronize with each other by engagement between the upper sector gears 19 and 19 when vertically swinging around the upper pivots 6 and 6.

Each lower arm 7 is integrally formed with a lower reinforcement plate 20 at the inner end of the bottom plate portion 7b so as rise in parallel with the threaded rod 4. The lower reinforcement plate 20 is formed with a flange 20a having tip ends bended in the right and left directions. The flange 20a is arranged such that its opposite ends abut on the inner surfaces of the opposite side plate portions 7a and 7a of each lower arm 7, preferably on the inner surfaces of the lower sector gears 18 and 18. A lower concave portion 28 is formed at the central portion in the upper surface of the flange 20a so as to receive a part of the outer peripheral surface of the threaded rod 4 when the load bearing platform 2 is lowered to a lowermost position.

Likewise, each upper arm 8 is integrally formed with a upper reinforcement plate 21 at the inner end portion of the bottom plate portion 8b so as rise in parallel with the threaded rod 4. The lower reinforcement plate 20 is formed with a flange 21a having tip ends bended in the right and left directions. The flange 21a is arranged such that its opposite ends abut on the inner surfaces of the opposite side plate portions 8a and 8a of each upper arm 8, preferably on the inner surfaces of the upper sector gears 19 and 19. An upper concave portion 29 is formed at the central portion in the lower surface of the flange 21a so as to receive a part of the outer peripheral surface of the threaded rod 4 when the base 1 is lowered to the lowermost position.

Referring to FIG. 2 again, a shaft hole 23 is provided at the central portion of the first connecting shaft 10 so as to be orthogonal to an axis of the first connecting shaft 10. Also, a threaded bore 24 is provided at the central portion of the second connecting shaft 11 so as to be orthogonal to an axis of the second connecting shaft 11. One end side of the threaded rod 4 is rotatably fitted in the upper shaft hole 23, and the other end thereof is screwed into the threaded bore 24.

A joint 25 is fixed by welding to one end of the threaded rod 4 on the side of the first connecting shaft 10. A thrust bearing 26 is mounted at a position adjacent to the joint 25. The thrust bearing 26 and a plurality of projections 27 bulged on the outer peripheral surface of the threaded rod 4 are arranged so as to abut on opposite side surfaces of the first connection shaft 10, whereby the threaded rod 4 is axially non-movably connected to the first connecting shaft 10.

Next, the operation of the present embodiment will be described.

As shown by a solid line in FIG. 1, when the jack J is in a folded state, if the threaded rod 4 is rotated in the normal direction with a rotation tool (not shown) connected to the joint 25, the first and second connecting shafts 10 and 11 approach each other, thereby raising the lower arms 7, 7 and the upper arms 8, 8 around the lower pivot 5, 5 and the upper pivot 6, 6, respectively.

At this time, the end surfaces of the disc-shaped outer bosses 14′ and 15′ formed at the outer surface of each lower arm 7 and each upper arm 8 so as to surround the upper pivots 6 and 6 and the lower pivots 6 and 6, rotatably abut on the inner surfaces of the base 1 and the load bearing platform 2. Therefore, rotational contact surfaces between the lower arms 7 and the base 1 as well as the upper arms 8 and the load bearing platform 2 are restricted to be small by the end surfaces of the outer bosses 14′ and 15′. As a result, a friction torque generated between the lower arms 7 and the base 1 as well as the upper arms 8 and the load bearing platform 2 is restricted to be small, thereby lightly raising the lower arms 7 and the upper arms 8 to smoothly raising the load bearing platform 2 (see a state shown by chain lines in FIG. 1). Therefore, an article such as an automobile body can be lifted up by the load bearing platform 2.

Further, the outer bosses 14′ and 15′ suppress the friction between the lower arms 7 and the base 1 as well as between the upper arms 8 and the load bearing platform 2, and also serve to lengthen support spans of the lower pivot receiving bores 12 and the upper pivot receiving bores 13 formed in the upper arms 7 and the lower arms 7. This arrangement effectively enhances support strength of the lower arms 7 and the upper arms 8 with respect to the lower pivots 5 and the upper pivots 6.

Furthermore, the opposite side plate portions 7a and 7a of each lower arm 7 is reinforced by the ribs 16 and 16 formed from the upper edge to the inner end edge, and particularly the inner end portion thereof is effectively reinforced by the lower sector gears 18 and 18 comprising the teeth-shaped ribs 16 and 16, thereby enhancing the bending rigidity. At the inner ends of the opposite side plate portions 7a and 7a of each lower arm 7, the outer side surfaces abut on the side plate portion 1a and 1a of the base 1 to restrict the outward falling, and the inner side surfaces thereof abut on the end surface of the flange portion 20a of the lower reinforcement plate 20 to restrict the inward falling. Therefore, even when a large load applied to the load bearing platform 2 is transmitted to the opposite side plate portions 7a and 7a of each lower arm 7, the falling of the opposite side plate portions 7a and 7a is reliably prevented. Particularly because the flange 20a is formed by bending the tip ends of the lower reinforcement plate 20, the flange 20a has a remarkably high buckling strength. Thus, when the flange 20a is caused to abut on the inner surfaces of the opposite side plate portions 7a and 7a of each lower arm 7, if the flange 20a is caused to abut also on the inner surfaces of the high-rigidity lower sector gears 18 and 18 as illustrated, the inward falling of the opposite side plate portions 7a and 7a of each lower arm 7 can be firmly prevented, thereby contributing to an improvement of durability of the lower arms 7 and 7.

Likewise, the opposite side plate portions 8a and 8a of each upper arm 8 is reinforced by the ribs 17 and 17 formed from the upper edge to the inner end edge, and particularly the inner end portion thereof is effectively reinforced by the lower sector gear 19 and 19 comprising the teeth-shaped ribs 17 and 17, thereby enhancing the bending rigidity. At the inner ends of the opposite side plate portions 8a and 8a of each upper arm 8, the outer side surfaces abut on the side plate portion 2a and 2a of the load bearing platform 2 to restrict the outward falling, and the inner side surfaces thereof abuts on the end surface of the flange portion 21a of the lower reinforcement plate 21 to restrict the inward falling. Therefore, even when a large load applied to the load bearing platform 2 is transmitted to the opposite side plate portions 8a and 8a of each upper arm 8, the falling of the opposite side plate portions 8a and 8a is reliably prevented. Particularly because the flange 21a is formed by bending the tip ends of the lower reinforcement plate 21, the flange 21a has a remarkably high buckling strength. Thus, when the flange 20a is caused to abut on the inner surfaces of opposite side plate portions 8a and 8a of each lower arm 8, if the flange 21a is caused to abut also on the inner surfaces of the high-rigidity lower sector gears 19 and 19 as illustrated, the inward falling of the opposite side plate portions 8a and 8a of each upper arm 8 can be firmly prevented, thereby contributing to an improvement of durability of the lower arms 8 and 8.

Further, when the load bearing platform 2 is lowered to the lowermost position, parts of the threaded rod 4 is received in the recesses 28 and 29 of the flange portions 20a and 21a of the lower and upper reinforcement plates 20 and 21 so as to abut on the inner surfaces of the recesses 28 and 29, thereby compactly be folding the jack J can without interference by the lower and upper reinforce plates 20 and 21. Furthermore, areas of the inner surfaces of the recesses 28 and 29 of the flange portions 20a and 21a on which the threaded rod 4 abuts are relatively large, thus avoiding damage to the threaded portion of the threaded rod 4.

The embodiment of the present invention has been described above, but various changes in design may be made without departing from the subject matter of the present invention.

What is claimed is:

1. A pantagraph-type jack comprising:
a base;
a load bearing platform;
a pair of right and left lower arms arranged into a V-shape, formed into an upwardly-opened angular U-shape in section, and having inner ends swingably connected through a pair of right and left lower pivots to the base;
a pair of right and left upper arms arranged into an inverted V-shape, formed into a downwardly-opened angular U-shape in section, and having inner ends swingably connected through a pair of right and left upper pivots to the load bearing platform;
outer ends of the right and left lower arms and outer ends of right and left upper arms being connected to each other via first and second connecting shafts, respectively;
a threaded rod supported on the first connecting shaft in a rotatable but axially non-movable manner, and screwed into a threaded bore provided in the second connecting shaft,
lower sector gears formed at the inner ends of the right and left lower arms so as to be meshed with each other; and
upper sector gears formed at the inner ends of the right and left upper arms so as to be meshed with each other,
wherein the pantagraph-type jack further comprises:
a lower reinforcement plate integrally provided at an inner end of a bottom plate portion of each lower arm so as to extend therefrom in parallel with the corresponding lower pivot, and integrally including a flange portion which has tip ends bending in right and left directions so as to abut on opposite side plate portions of each lower arm;
a lower recess formed in an upper surface of the flange portion of each lower enforcement plate so that the lower recess receives a part of an outer peripheral surface of the threaded rod when the load bearing platform is lowered to a lowermost position;
an upper reinforcement plate integrally provided at an inner end of an upper plate portion of each upper arm so as to extend therefrom in parallel with the corresponding upper pivot, and integrally including a flange portion which has tip ends bending in right and left directions so as to abut on opposite side plate portions of each upper arm; and
an upper recess formed in an lower surface of the flange portion of each upper enforcement plate so that the upper recess receives a part of an outer peripheral surface of the threaded rod when the load bearing platform is lowered to a lowermost position.

2. The pantagraph-type jack according to claim 1, further comprising:
an inwardly-bending rib formed from an upper edge of the opposite side plate portions to an inner edge of each lower arm, a part of the rib comprising the lower sector gear, the flange portion of the lower enforcement plate abutting on an inner side surface of the lower sector gear; and
an inwardly-bending rib formed from a lower edge of the opposite side plate portions to an inner edge of each upper arm, a part of the rib comprising the upper sector gear, the flange portion of the upper enforcement plate abutting on an inner side surface of the upper sector gear.
